(19) United States
(12) Patent Application Publication
(10) Pub. No.: US 2013/0272455 A1
(43) Pub. Date: Oct. 17, 2013

(54) SYSTEMS AND METHODS FOR CLOCK COMPENSATION

(71) Applicant: QUALCOMM INCORPORATED, San Diego, CA (US)

(72) Inventors: Sandip HomChaudhuri, Santa Clara, CA (US); Alireza Raissinia, Monte Sereno, CA (US)

(73) Assignee: QUALCOMM INCORPORATED, San Diego, CA (US)

(21) Appl. No.: 13/684,973

(22) Filed: Nov. 26, 2012

Related U.S. Application Data
(60) Provisional application No. 61/624,200, filed on Apr. 13, 2012.

(51) Int. Cl. H04L 27/26

(52) U.S. Cl. CPC H04L 27/2647
USPC 375/340

(57) ABSTRACT

In a wireless communication system including a transmitter device and a receiver device, the receiver device may be configured to awake from a low power mode to receive beacons from the transmitter device. The receiver device may awaken an early reception interval prior to the beacon arrival time determined by the local clocks to account for inaccuracies in the local clocks and the transmitter clock. The early reception interval may be dynamically adjusted based upon an estimation of the clock errors to minimize the early reception interval.

### RELATED APPLICATIONS

The present application claims priority of pending provisional patent application Ser. No. 61/624,200 entitled SYSTEM AND METHOD FOR CLOCK COMPENSATION, filed Apr. 13, 2012.

### FIELD OF THE PRESENT INVENTION

This disclosure generally relates to wireless communication systems and more specifically to systems and methods for reducing power consumption through clock compensation.

### BACKGROUND OF THE INVENTION

Wireless networks are increasingly employed to provide various communication functions including voice, video, packet data, messaging and the like. Particularly with regard to mobile devices that are battery powered, minimizing energy consumption is an important aspect in the design of such systems. To that end, wireless communication systems such as wireless local area networks (WLANs) typically include various power saving techniques. For example, the IEEE 802.11 standards include provisions for a delivery traffic indication message (DTIM) to coordinate the delivery of data around a period of time called the listen interval (LI), during which a network node such as a client station (STA) may enter a low power, or sleep, mode. Another network node, such as an access point (AP) will queue data during the LI for delivery to the STA at a later time. The STA awakens at the end of each LI to receive a beacon containing the DTIM from the AP. If the DTIM indicates data is ready for transmittal, the STA will respond to the AP to initiate the transfer. Otherwise, the STA will return to sleep mode for another LI. This coordination between the STA and AP requires that their clocks be synchronized. To some degree, this is accomplished each time a frame is successfully received by the STA through the timing synchronization function (TSF).

However, the STA keeps track of time using a local clock, which is subject to inaccuracies. Notably, many systems employ a lower frequency clock than the normal clock during sleep mode to save power, but such clocks are less accurate than the normal, higher frequency clock and may contribute to significant drift over the LI. Further, even during active reception when the STA may employ the more accurate clock, some degree of error may be present. Also, the AP clock is subject to drift which may affect the synchronization with the STA. In conventional systems, the maximum errors associated with the design of the clocks are summed to determine an early activation interval as a buffer period, termed herein Early-RX. The STA receiver is then powered up prior to the anticipated beacon transmission by an amount of time corresponding to the Early-RX, ensuring that the STA receiver is activated when the AP transmits its beacon.

Considerable power is consumed when the STA is activated, including energizing the radio frequency (RF) section, the analog front end and the digital baseband. Accordingly, it is desirable to postpone activation of the STA receiver as long as possible to maximize efficiency. This effect is illustrated by the relationship of the Early-RX to beacon reception. The TSF field operates at a resolution of one microsecond, and the transmission unit (TU) is approximately 1.024 ms. Typically the total duration of receiving a beacon is marginally greater than 1TU (˜1.6 ms) and in long beacons, it may be up to 2-3 ms. The inaccuracies comprising the Early-RX may be approximately 200 μs or longer, and generally increase as the interval between beacons increases. Thus, particularly when only the beacon is received and there is no need to stay awake for any data reception, powering the receiver during the Early-RX period represents a substantial portion of the overall power consumption of the STA.

Therefore, what has been needed at least are systems and methods to compensate for inaccuracies in the clocks of wireless communication devices. This invention accomplishes these and other goals.

### SUMMARY OF THE INVENTION

In accordance with the above needs and those that will be mentioned and will become apparent below, this specification discloses methods for wireless communication in a system having a transmitter device and a receiver device, wherein the receiver device knows a specified time interval at which a transmitter device is to periodically send a beacon, including the steps of operating the receiver device in a low power mode for at least a portion of the specified time interval, determining at the receiver device a first activation offset corresponding to a clock inaccuracy at the receiver device with respect to the transmitter device, determining at the receiver device an early reception interval based on the first activation offset, and activating the receiver device a duration of time corresponding to the early reception interval prior to a scheduled beacon transmission from the transmitter device. Determining the first activation offset may include either or both calculating a frequency-derived offset and calculating a time correlation-derived offset.

In one aspect, the clock inaccuracy may include errors between a transmitter clock used to modulate a digital signal into symbols with respect to a first receiver clock used to demodulate the symbols. Additionally, the methods may include tracking using a second clock time spent operating the receiver device in the low power mode, determining at the receiver device a second activation offset corresponding to clock inaccuracy present in the second clock, and adjusting the early reception interval based on the second activation offset. As such, adjusting the early reception interval may include changing a number of timing pulses from the second clock that are counted before entering active mode. Adjusting the early reception interval may also include varying a frequency of the second clock.

In another aspect, determining the second activation offset may include sensing an operational temperature of the receiver device and estimating a clock error correlated to the operational temperature. Further, a distance of a source of the second clock relative to a location of the temperature sensor may be determined and a temperature difference correction based on a chip temperature profile related to differences in the location may be applied.

In yet another aspect, determining the second activation offset may include estimating a clock error based on an operational condition of the receiver device.

Further, determining the second activation offset may include performing a piecewise linear estimation of clock error over time.

Another aspect includes receiving by the receiver device a beacon during the scheduled beacon transmission from the transmitter device, verifying an identification value associated with the beacon, and determining the early reception interval at least partially based on the first activation offset if the verification confirms the beacon originated from the transmitter device.

This disclosure is also directed to systems for wireless communication including a receiver device for receiving wireless communications from a transmitter device, wherein the receiver device knows a specified time interval at which the transmitter device is to periodically send a beacon, such that the receiver device may have a first compensator configured to determine a first activation offset corresponding to a clock inaccuracy at the receiver device with respect to the transmitter device, wherein the receiver device is configured to operate in a low power mode for at least a portion of the specified time interval, is configured to determine an early reception interval based on the first activation offset and is configured to activate a duration of time corresponding to the early reception interval prior to a scheduled beacon transmission from the transmitter device.

In one aspect, the first compensator may be configured to determine the first activation offset by calculating a frequency-derived offset, by calculating a time correlation-derived offset or both.

In another aspect, the clock inaccuracy may include errors between a transmitter clock used to modulate a digital signal into symbols with respect to a first receiver clock used to demodulate the symbols.

The receiver device may also include a second clock configured to track time spent operating in the low power mode and a second compensator configured to determine a second activation offset corresponding to a clock inaccuracy present in the second clock, wherein the receiver device is configured to adjust the early reception interval based on the second activation offset. In addition, the receiver device may adjust the early reception interval by changing a number of timing pulses from the second clock that are counted before entering active mode. Further, the receiver device may adjust the early reception interval by varying a frequency of the second clock.

In yet another aspect, the receiver device may include a temperature sensor such that the second compensator may determine the second activation offset by sensing an operational temperature of the receiver device with the temperature sensor and estimating a clock error correlated to the operation temperature. Further, the second compensator may correct the operational temperature based on a chip temperature profile related to differences in location and a distance of a source of the second clock source relative to a location of the temperature sensor. In another aspect, determining the second activation offset may include performing a piecewise linear estimation of clock error over time.

In another aspect, the second compensator may determine the second activation offset by estimating a clock error based on an operational condition of the receiver device.

As desired, the receiver device may also be configured to receive a beacon during the scheduled beacon transmission, verify an identification value associated with the beacon and determine the early reception interval at least partially based on the first activation offset if the verification confirms the beacon originated from the transmitter device.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 depicts the relative timing and power usage of various stages of WLAN reception for a STA;

FIG. 2 depicts a schematic diagram of a wireless communication system including an AP and a STA, according to one embodiment of the invention; and

FIG. 3 depicts a flow chart of a suitable routine for determining a frequency-derived timing offset, according to one embodiment of the invention;

FIG. 4 depicts a flow chart of a suitable routine for determining a time correlation-derived timing offset, according to one embodiment of the invention; and

FIG. 5 depicts a timing diagram of WLAN reception stages comparing a conventional STA to a STA according to one embodiment of the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the invention in any manner and may change depending upon context. Further, sequential terms such as first and second may be used to distinguish similar elements, but may be used in other orders or may change also depending upon context.

Further, embodiments are discussed in specific reference to wireless networks. As such, this disclosure is applicable to any suitable wireless communication systems having the necessary characteristics. Although discussed in specific reference to an infrastructure WLANs, the techniques of this disclosure may be applied to other network configurations and topologies, such as ad hoc or peer-to-peer networks, or to other wireless communication systems involving periodic beacon transmissions employing a transmitter device and a receiver device.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

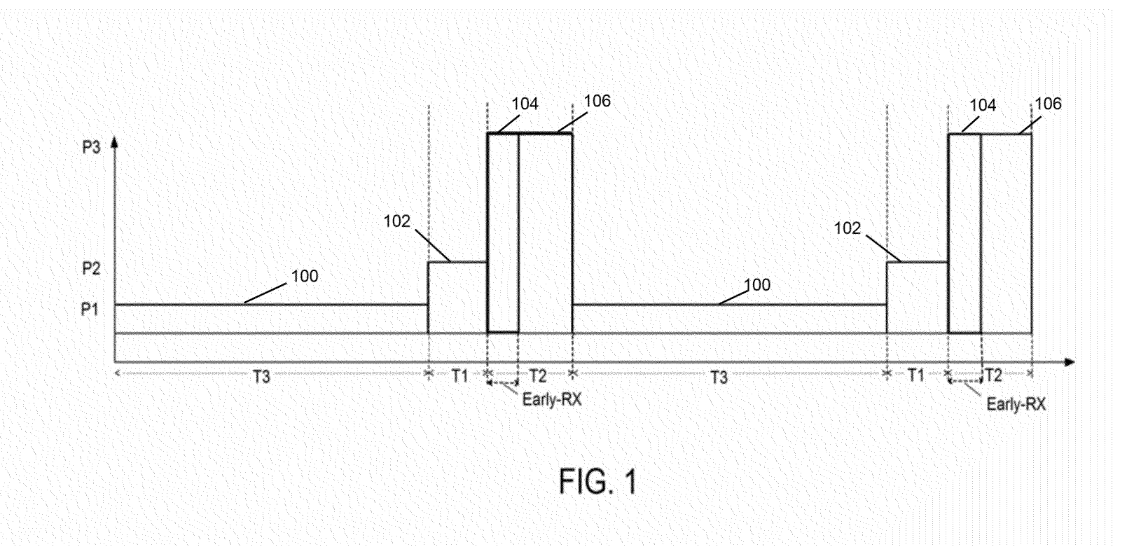

FIG. 1 graphs the relative timing and power usage of various stages of a WLAN STA. Area 100 represents the STA during a low power mode for a LI in between DTIM beacons sent by the AP. During this stage, either of or both the clock and power circuitry may be gated, or other mechanisms employed, to shut down the WLAN receiver system, allowing the STA to “sleep” for the duration of the DTIM interval.

As shown, area 100 corresponds to a minimal power usage, P1, and has a period with a duration of T3. In preparation for receiving the DTIM beacon, STA may enter a pre-reception period indicated by area 102 during which clock circuitry, such as a crystal driven oscillator (XO), may be activated, phase locked loops (PLLs) may be allowed to settle into a stable condition and registers may be restored. Area 102 is associated with an increased power usage of P2 and has a duration of T1 which may be a fixed period, with respect to this disclosure.

Next, the WLAN receiver of the STA may be fully activated. This may include the receiver portion of the RF system being energized, as well as the analog front end and digital baseband being made operational so that a beacon sent by the AP may be properly received and processed. As shown, this activation occurs prior to the calculated arrival of the beacon to account for the clock inaccuracies discussed above. Since the clocks of the STA and AP may drift after each successful synchronization, particularly during the LI, the receiver is preferably activated early enough to ensure that it is fully functional when the beacon arrives, even if timing errors cause the beacon to arrive earlier than the time determined by the local time keeping functions. This margin of error is termed the Early-RX period and corresponds to area 104, having a duration that is sufficiently long to compensate for any clock inaccuracies.

Finally, the STA may receive the beacon and any following packets during the main reception period represented by area 106. The overall period of time during which the WLAN receiver is fully active is the duration T2. As shown, the power usage P3 during the Early-RX period may be the same as during active reception of a packet in the main reception period. Thus, power consumption during the Early-RX period can be significant when no beacon is received. In experimental tests, the amount of power expended during the Early-RX period may represent 12-40% of the overall power expended by the STA during WLAN standby reception, as profiled on a medium sized beacon of 150 bytes. Accordingly, the efficiency of the STA may be improved by minimizing the Early-RX period. Techniques of this disclosure are directed at least to dynamically providing a more accurate estimate of clock inaccuracies of the transmitter and receiver so that the Early-RX period may be lowered. Further, these techniques may be implemented locally, requiring no changes on the transmitter side of the communications link.

The baseline for timing the start of the Early-RX period is determined from the TSF information that is typically included in frames sent by the AP including the DTIM beacons, and is referred to as target beacon transmission time (TBTT). These frames are processed by the media access control (MAC) layer of the STA to derive the TSF and synchronize the local clock of the STA with the clock of the AP. The STA is then able to determine, subject to the clock inaccuracies, the expected time at which the next DTIM beacon will be transmitted. As noted above, the resolution of the TSF is one TU, which in one embodiment is 1024 μs. However, Early-RX periods may have a resolution on the order of less than one TU, e.g., hundreds of μs. Thus, adjustments to minimize the requisite Early-RX period at sub-TU resolutions might not be readily implemented in the MAC layer.

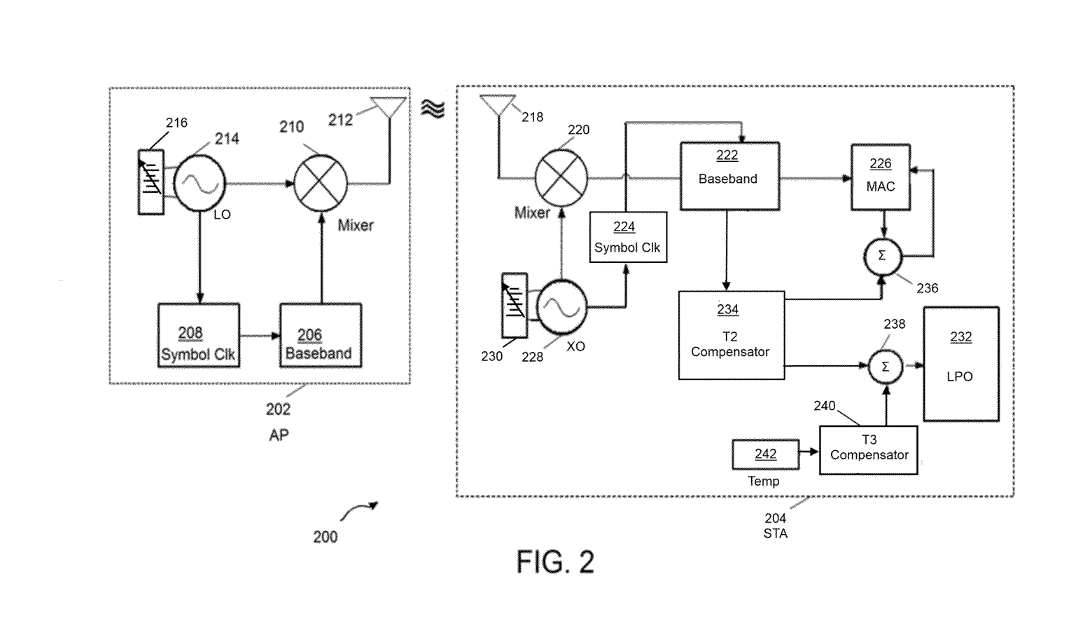

Turning now to FIG. 2, a schematic representation of a wireless communication system 200 featuring a transmitter device, AP 202, and a receiver device, STA 204, is shown. The components of AP 202 generally comprise a baseband module 206, which modulates a digital bit stream to a series of symbols at the clock rate of symbol clock generator 208. The symbols are converted to an analog signal which is fed to mixer 210 for conversion to RF and then transmitted over antenna (or in another embodiment, plurality of antennas) 212. In this example, local oscillator (LO) 214 is regulated by voltage source 216 and drives both mixer 210 and symbol clock generator 208. In one embodiment, LO 214 is relatively accurate, having an error of approximately +/−20 ppm in some embodiments. In other applications, a separate oscillator for each component may be used, and generally provide similar accuracies. Further, although the embodiment depicted represent a conventional, infrastructure WLAN involving an AP and a STA, the techniques of this disclosure may also be applied to ad hoc, peer-to-peer, soft-AP, P2P Go and other network configurations.

Similarly, FIG. 2 also shows the relevant components of STA 204 involved in receiving and processing the signal transmitted by AP 202. Antenna (or in another embodiment, a plurality of antennas) 218 receives the signal from AP 202 which is then downconverted to analog baseband signal at the appropriate frequency by mixer 220, digitized and fed to baseband module 222. Baseband module 222 demodulates the symbols at the rate of symbol clock generator 224 and delivers the reconstructed digital bit stream to the MAC layer 226. As shown, mixer 220 and symbol clock generator 224 are both driven by the same clock, which includes crystal oscillator (XO) 228 regulated by voltage source 230. In one embodiment, the clock signal generated by XO 228 is relatively accurate and has a similar error as local oscillator 214, e.g., +/−20 ppm or less (and such error may be dictated by the 802.11 standards).

In this embodiment, another local clock, low power oscillator (LPO) 232, is used to track the LI. In one embodiment, LPO 232 consumes less power than XO 228 to increase efficiency during the DTIM sleep period. Examples of suitable LPOs include those implemented using semiconductors to create series of inverters or buffers in a positive feedback configuration, such as a ring oscillator. Although these LPOs require significantly less power to operate, they may suffer from greater inaccuracy. Furthermore, the frequency generated by such circuits may vary dependent upon ambient or circuit temperature. Accordingly, the error associated with the use of an LPO may be greater than crystal based clock, e.g., approximately +/−250 ppm, and vary depending upon the operating temperature of the LPO circuitry. As discussed below, techniques of this disclosure accommodate these characteristics (e.g., by performing a dynamic determination of the LPO error).

Decreasing the Early-RX period by implementing techniques of this disclosure begins with establishing an initial Early-RX period that corresponds to the anticipated maximum error of the various clock sources. Based upon operation of STA 204, as described below, an estimation of the inaccuracies of the associated clocks may be dynamically determined and applied to decrease the initial Early-RX period for the reception of subsequent beacons. In view of the architecture of system 200, the clock inaccuracies that may be compensated in establishing a decreased Early-RX period include the errors associated with LO 214, XO 228 and LPO 232. Two aspects of the present disclosure account for these inaccuracies: (1) the system may account for errors in the T2 time period (FIG. 1) and (2) the system may account for the errors in T3 time period (FIG. 1).

In accounting for errors in the T2 time period, the relevant clock inaccuracies may include the errors associated with LO 216 on the transmission side and XO 226 on the receiving side. Referring to FIG. 2, STA 204 includes T2 compensator 234 that may be configured to determine these errors. As will be described below, T2 compensator 234 may be configured to determine the difference between the LO 214 clock and the XO 228 clock based on frequency characteristics of the signal received by STA 204 or based on a time correlation process involving a received frame. This difference is referred to herein as the T2 offset.

In one embodiment, these techniques are applied only to communications between AP 202 and STA 204 as it is the synchronization with AP 202 that is relevant for the infrastructure mode of operation. As will be described, basic service set identifier (BSSID) filtering may be performed to ensure that only packets originating from AP 202 are utilized to adjust the Early-RX period. For a WLAN architecture, when a basic service set (BSS), including an AP (or a device functioning as an AP) and all of its associated STAs, is established, a unique identifier (BSSID) is assigned to the BSS. Typically, the BSSID is the MAC address of the AP. In ad hoc networks, the unit is termed an independent basic service set (IBSS) and the identifier is a generated MAC address. The method for BSSID filtering may depend upon the nature of the packets being transmitted by the AP.

Packets adhering to the very high throughput (VHT) standard include a partial association identification (pAID) field as part of the VHT preamble. In at least some embodiments, the pAID is given by equation (1):

pAID=mod(dec(AID[0:8])+dec(BSSID[44:47]XORBSSID[40:43])*2⁵)mod2⁹, (1)

wherein mod refers to a modulo operation and dec refers to a conversion operation from hexidecimal to decimal. Accordingly, the BSSID may be part of the pAID encode which can be decoded by the physical (PHY) layer of the receiver. In one embodiment, the VHT receiver PHY may not deliver a carrier frequency offset (CFO) error to the MAC as it identifies a pAID match failure, meaning that the frame is not transmitted by the BSS AP. In another embodiment, the VHT receiver PHY may deliver the CFO error together with an indication that pAID match fails and such that the MAC may be configured not to use it. Accordingly, an inherent filtering may occur with respect to VHT packets.

For non-VHT packets, it may be desirable to wait until the MAC layer can process the information and determine the source of the packet. Accordingly, T2 compensator 234 may still be configured to determine the T2 offset, however, in one embodiment, the offset may be applied to adjust the Early-RX period as described below only after the MAC 226 confirms the packet originated from AP 202.

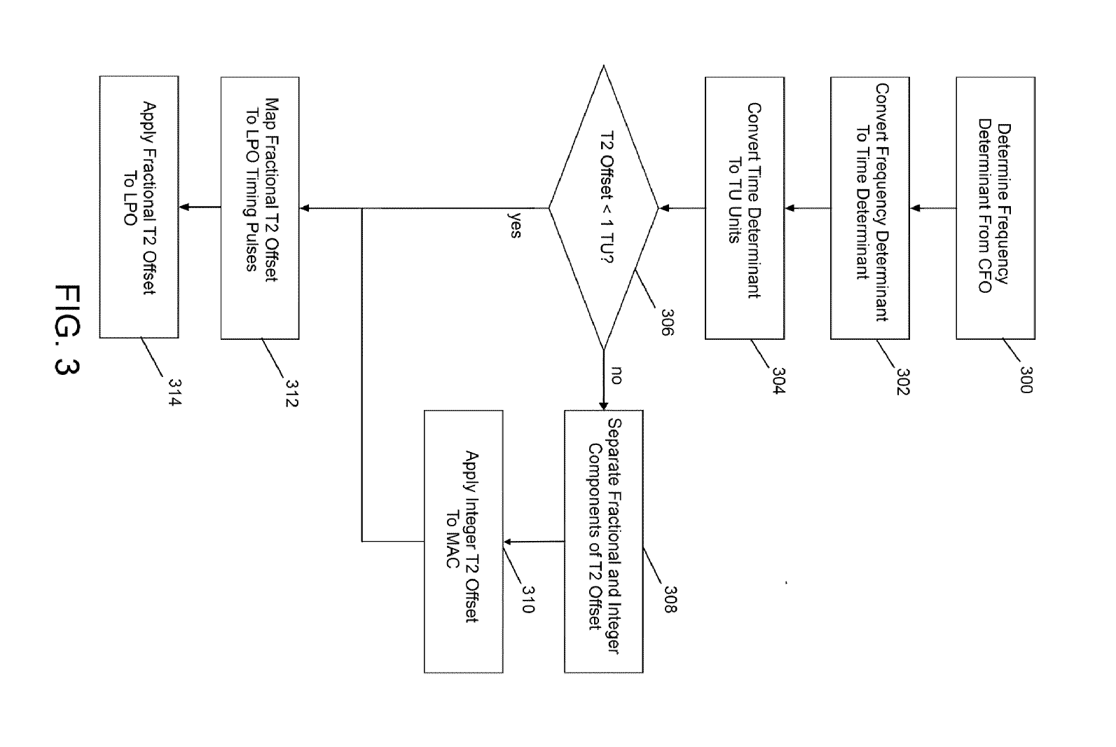

As referenced above, T2 compensator 234 may be configured to determine a frequency-derived T2 offset in one aspect of the disclosure. FIG. 3 depicts a flow chart showing a suitable routine for determining a frequency-derived T2 offset. Beginning with step 300, T2 compensator 234 may calculate a frequency determinant corresponding to the carrier frequency offset (CFO). The CFO may be conventionally determined during operation of STA 204. The frequency determinant may then be converted to a time determinant corresponding to the T2 offset in step 302 The conversion may be implemented using a look up table, or where the relationship is sufficiently linear or otherwise mapable, by using a suitable equation with the appropriate coefficients. The time determinant corresponding to the T2 offset may be expressed in TU units as represented by step 304. In step 306, T2 compensator 234 may be configured to determine whether the T2 offset length is less than one TU. If the T2 offset length is greater than or equal to one TU, the integer value and fractional value of the offset are parsed in step 308. Referring back to FIG. 2, the integer value may be used to directly adjust the TSF value in MAC 226 through summation module 236 as indicated by step 310. Any residual fractional value may be below the resolution of the MAC TSF counter and is mapped to the corresponding number of timing pulses of LPO 232 in step 312 and used to adjust LPO 232 through summation module 238 in step 314, as depicted in FIG. 2. Alternatively, if the T2 offset is less than one TU as determined in step 308, the process simply moves to step 312 and the fractional value is mapped to the timing pulses of LPO 232 and subsequently applied as described.

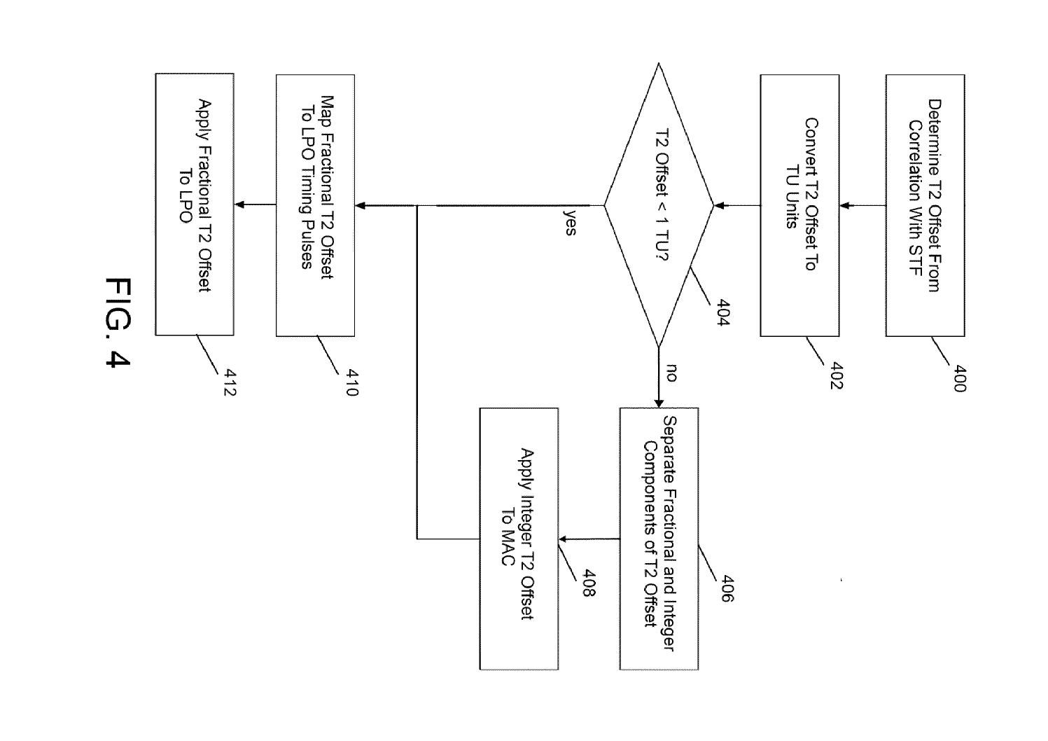

In another aspect, T2 compensator 234 may be configured to determine a time correlation-derived T2 offset. FIG. 4 depicts a flow chart showing a suitable routine for determining a time correlation-derived T2 offset. Beginning with step 400, T2 compensator 234 may perform a time-domain correlation process involving the short training field (STF) of the packet preamble. In this process, the STF self-correlation may be performed over multiple time offsets beginning at the start of the initial Early-RX period. As desired, the correlation may be performed using a dedicated time tracking block that operates in conjunction with the STF correlation that occurs during conventional operation of STA 204. In step 402, the time offset corresponding to a local maximum in the STF correlation may be identified as the T2 offset and expressed in TU units. In a similar manner to that described with regard to FIG. 3, T2 compensator 234 may be configured to determine whether the T2 offset length is less than one TU in step 404. Accordingly, the integer value and fractional value of the T2 offset may be separated in step 406, and the integer value used to adjust the TSF value in step 408 through summation module 236. The fractional value from step 406 or step 404 may then be mapped to the timing of LPO 232 in step 410 and used to adjust LPO 232 in step 412 through summation module 238.

As desired T2 compensator 234 may determine and apply either the frequency-derived and time-correlation-derived T2 offsets, depending upon the embodiment. When both techniques are implemented, the appropriate offset may be selected and applied to adjust the Early-RX period. Typically, the same oscillator may be used for symbol generation and RF mixing in both AP 202 and STA 204. As a result, the frequency-derived and time-correlation-derived T2 offsets may be equivalent, as the same clock source is being employed for the RF, MAC and PHY sections. However, if different clock sources are employed or if there is a discrepancy between the two values, in one embodiment the time-correlation-derived T2 offset is used as it might be more precise than the frequency-derived T2 offset. In embodiments where T2 compensator 234 performs only one technique for determining the T2 offset, that value may be used directly.

The second source of clock inaccuracy is associated with the use of LPO 232 to track the LI between DTIM beacons during the T3 time period (FIG. 1), termed herein the T3 offset. As such, STA 204 may include T3 compensator 240. Although the primary embodiments of T3 compensator 240 are discussed herein with reference to LPO 232, a suitable T3 compensator may be configured to provide an error estimate for any clock source used to track the LI for use with the techniques of this disclosure.

In one embodiment, the maximum ppm error of LPO 232 may be used to estimate the drift expected over a time corresponding to the LI. In another embodiment or the same embodiment, a more precise estimation of the error associated with LPO 232 that varies with time may be used. For example, a look up table having entries for various modes of receiver operation may be employed, such as reception of the DTIM beacon and then sleep, reception of the DTIM beacon and Content After Beacon (CAB) timeout and then sleep, reception of the DTIM beacon and packet reception for specific periods of time and then sleep, and the like. Accordingly, an appropriate offset may be selected based upon the receiver's operating condition during one or more beacon receptions.

Alternatively, since the operating frequency of LPO 232 may vary with temperature, on-die temperature sensor 242 may be configured to convey information regarding the thermal characteristics of LPO 232 to T3 compensator 240. For example, the chip temperature lowers when the chip switches from an active reception phase to DTIM sleep. A look up table having the expected second order drift rate (such as rate of change of ppm) correlated to time and temperature may be provided. The values for the look up table may be determined during a chip characterization process. The piecewise linear (or mapable) ppm drift rates, obtained from the look-up table, may now be applied over one or more zones in the T3 period to provide an estimate of clock drift associated with LPO 232 over the LI. The look-up table may provide an accurate enough estimate as the drift rate is expected to be higher immediately after the beacon reception and may lower as time progresses.

As noted above, in some embodiments, the look up table may be constructed in view of the second order drift rate, the rate of change of ppm. A PPM_max may be a value associated with the maximum error associated with LPO 232 (such as 250 ppm.) As temperature rolls off following active beacon reception, the ppm may drop to a PPM_min value. Accordingly, a look-up table may be constructed showing the PPM_max to PPM_min on one row mapped against different time-intervals (the sum of which being the LI). A total Early-RX period is illustrated by Equation (2):

Early_{—}rx_time=offset_{T2}+t₁*drift₁_{_{—}}lpo++₂*drift₂_{_{—}}lpo+ . . . +tₙ*driftₙ_{_{—}}lp0 (2)

wherein, t₁+t₂+ . . . tₙ=LI, and driftₙ_{_{—}}lpo is the appropriate error value from the table.
The look up table may have data for several temperature nodes, such as a starting temperature after the last WLAN activity, at various temperature points (e.g., sensed immediately following receiver activity), and as the STA is put into low power mode.

Further, temperature sensor 242 may be used by other functional systems of STA 204 and may not be located immediately adjacent to LPO 232 (though not required to not be located immediately adjacent to LPO 232). Accordingly, a scaling factor may be characterized and applied to achieve a more accurate measurement of the LPO 232 temperature. This may include making a determination of the location of temperature sensor 242 relative to LPO 232 and correcting for any temperature difference based on a chip temperature profile.

As will be appreciated, any suitable combination of the approaches above may be used as desired to obtain a dynamic determination of the error currently associated with LPO 232. In an embodiment, every time the chip wakes up from sleep (or alternatively, periodically), the LPO's clock frequency error may be calibrated with respect to the more accurate symbol clock (e.g., +/−20 ppm) to keep track of the changes due to aging and/or operational temperature. In another embodiment, this calibration procedure may be performed several time during active reception (i.e., not just during beacon reception, but also times, e.g., when the STA is receiving or transmitting other frames, thus creating more opportunities to calibrate the LPO 232 to assist in minimizing the Early-RX period).

T3 compensator 240 is preferably configured to map any determined offset corresponding to operation of LPO 232 over the LI to a corresponding number of pulses of LPO 232. For example, an LPO 232 operating at 200 kHz generates a clock pulse every 5 μs. The converted T3 offset value, expressed in pulses of the LPO 232, may be applied to summation module 252 which adjusts LPO 232 to achieve a minimized Early-RX as discussed below.

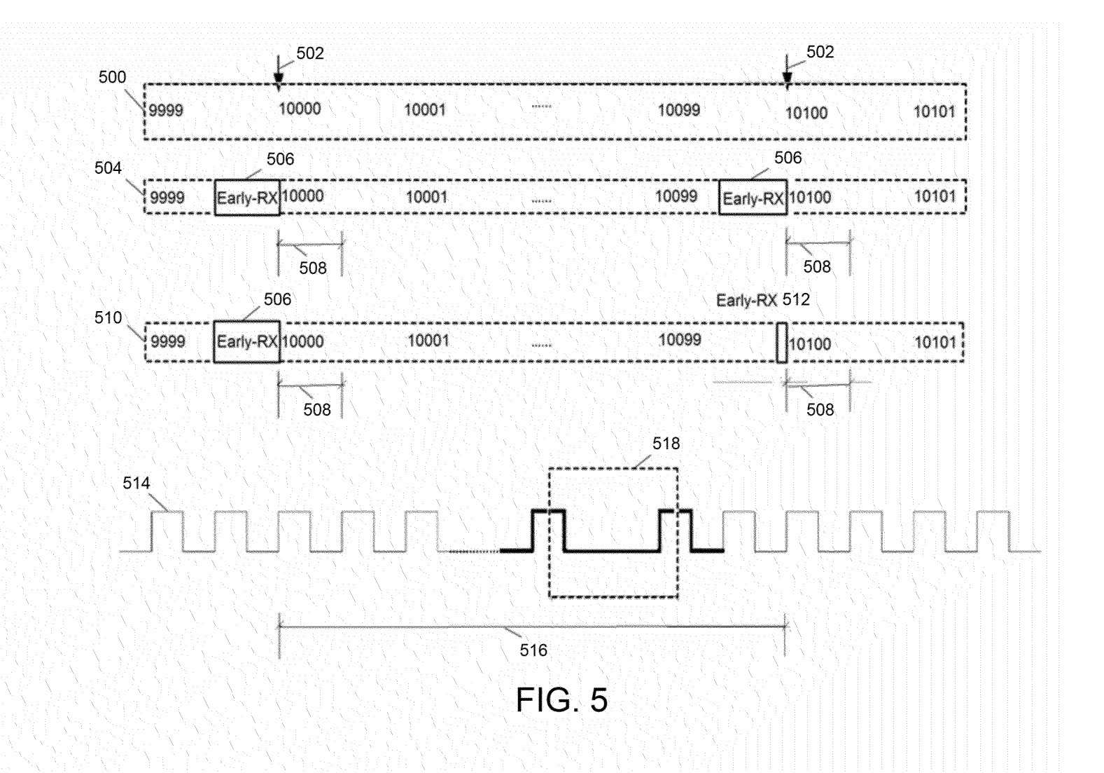

FIG. 5 depicts the timing of system 200 as compared to a conventional client/receiver device that utilizes a static Early-RX period in reference to the timing pulses of a suitable LPO. Band 500 depicts the TSF timer of an AP such as AP 202, which marks time in increments of one TU. In this embodiment, the LI is 100 TUs, so that a beacon 502 containing the TSF information from AP 202 is transmitted every 100 TUs. Band 504 represents the timer of a conventional receiver device. Synchronization is achieved with AP 202 following reception of each beacon 502. However, the receiver device may be configured to activate the WLAN receiver prior to the anticipated arrival of the beacon to compensate for the inaccuracies of the clocks in the receiver device and the AP, as discussed above. This is depicted in FIG. 5 as a fixed interval Early-RX period 506 applied prior to the scheduled transmittal of the beacon. The beacon may be received and processed during the main reception period 508, followed by the receiver device entering the low power sleep mode. The receiver device may be awakened at the same time relative to the scheduled arrival of each beacon 502, as dictated by fixed Early-RX period 506. As shown, the reception of beacon 502 occurs within one TU. Accordingly, the time spent during Early-RX period 506 when no data is being received may represent a considerable inefficiency, even though the Early-RX period 506 may be less than one TU.

In contrast, the timing of STA 204, as shown in band 510, may use an adaptive Early-RX period that is dynamically adjusted based upon estimations of the actual clock errors as described above. For example, the T2 offset may be determined from the characteristics of each current beacon 502 and may then be applied to adjust the Early-RX period 512 for receiving the subsequent beacon 502. Likewise, the T3 offset may vary over time, particularly in correlation to the temperature of the LPO 332 (FIG. 2), and therefore may be determined dynamically. Accordingly, STA 204 may employ an initial, conventionally determined Early-RX period 506, for the reception of a one or more initial beacons of the beacons 502. However, using the T2 and T3 offsets determined from T2 compensator 234 and T3 compensator 240, the timing of LPO 232 may be adjusted to provide a reduced Early-RX period 512 for subsequent beacons. Notably, these techniques do not require adjusting the LI itself. The LI may be established through the association process with AP and might not be directly affected by the adjustments to the LPO timing. Rather, the techniques of this disclosure involve adjustments to the timing of the receiver being activated at the end of the LI in anticipation of receiving the beacon from the AP, and may involve sub-TU level adjustments.

The depicted square wave timing signal 514 represents the clock generated by LPO 232. In one aspect, adjustment to the LPO 232 may be made at a resolution corresponding to the timing pulse duration. From the discussion above, the T2 and T3 offsets may be mapped to a number of clock pulses at the LPO frequency. The integer portion of this value may be directly compensated by increasing or decreasing the number of pulses counted during the LI to adjust the Early-RX period in increments of the period of the operating frequency of the LPO. In one example, as noted above, an LPO operating at 200 kHz has a resolution corresponding to the period of 5 μs.

In a further aspect, adjustments may be made to the LPO timing at a finer resolution, which corresponds to the residual fractional value of mapping the T2 and T3 offsets to the number of LPO pulses. This degree of control may be achieved by varying the frequency of the LPO through constriction or dilation of the timing signal as represented by block 518, which may be implemented as part of LPO 232 (FIG. 2). This adjustment may be made in any suitable manner, such as when the LPO clock was derived from a higher frequency reference clock and adjusting pulses of the higher frequency clock, which results in adjustment at a sub-pulse level for the LPO clock.

As shown in FIG. 5, the Early-RX period may be adjusted to a marginal value rather than attempting to completely remove the Early-RX period as some portion may be desired to allow RF, analog and/or digital BB blocks to power up and be ready for beacon reception. Even though the techniques of this disclosure provide a more precise estimation of the clock offsets during the T2 and T3 time periods, some residual errors may still exist. Accordingly, it may also be desirable to maintain some portion to guard against an error of the beacon arriving before the receiver is fully activated. This marginal value may be obtained by multiplying the combined T2 and T3 offsets by some fractional coefficient configured to retain the desired degree of protection against clock inaccuracies. In one embodiment, the combined T2 and T3 offsets are multiplied by a coefficient in the range of 0.80 and 0.99, such as approximately 0.95, to retain this margin of error.

Described herein are presently preferred embodiments. However, one skilled in the art that pertains to the present invention will understand that the principles of this disclosure can be extended easily with appropriate modifications to other applications.

What is claimed is:

1. A method for wireless communication by a receiver device, wherein the receiver device knows a specified time interval at which a transmitter device is to periodically send a beacon, comprising:
operating the receiver device in a low power mode for at least a portion of the specified time interval;
determining at the receiver device a first activation offset corresponding to a clock inaccuracy at the receiver device with respect to the transmitter device;
determining at the receiver device an early reception interval based on the first activation offset; and
activating the receiver device a duration of time corresponding to the early reception interval prior to a scheduled beacon transmission from the transmitter device.

2. The method of claim 1, wherein determining the first activation offset comprises calculating a frequency-derived offset.

3. The method of claim 1, wherein determining the first activation offset comprises calculating a time correlation-derived offset.

4. The method of claim 2, wherein determining the first activation offset further comprises calculating a time correlation-derived offset.

5. The method of claim 1, wherein the clock inaccuracy comprises errors between a transmitter clock used to modulate a digital signal into symbols with respect to a first receiver clock used to demodulate the symbols.

6. The method of claim 5, further comprising:
tracking using a second clock time spent operating the receiver device in the low power mode;
determining at the receiver device a second activation offset corresponding to clock inaccuracy present in the second clock; and
adjusting the early reception interval based on the second activation offset.

7. The method of claim 6, wherein adjusting the early reception interval comprises changing a number of timing pulses from the second clock that are counted before entering active mode.

8. The method of claim 7, wherein adjusting the early reception interval further comprises varying a frequency of the second clock.

9. The method of claim 6, wherein determining the second activation offset comprises sensing an operational temperature of the receiver device and estimating a clock error correlated to the operational temperature.

10. The method of claim 9, further comprising determining a distance of a source of the second clock relative to a location of the temperature sensor and correcting for temperature difference based on a chip temperature profile related to differences in the location.

11. The method of claim 6, wherein determining the second activation offset comprises estimating a clock error based on an operational condition of the receiver device.

12. The method of claim 6, wherein determining the second activation offset comprises performing a piecewise linear estimation of clock error over time.

13. The method of claim 1, further comprising:
receiving by the receiver device a beacon during the scheduled beacon transmission from the transmitter device;
verifying an identification value associated with the beacon; and
determining the early reception interval at least partially based on the first activation offset if the verification confirms the beacon originated from the transmitter device.

14. A receiver device for receiving wireless communications from a transmitter device, wherein the receiver device knows a specified time interval at which the transmitter device is to periodically send a beacon, comprising a first compensator configured to determine a first activation offset corresponding to a clock inaccuracy at the receiver device with respect to the transmitter device;
wherein the receiver device is configured to operate in a low power mode for at least a portion of the specified time interval, is configured to determine an early reception interval based on the first activation offset and is configured to activate a duration of time corresponding to the early reception interval prior to a scheduled beacon transmission from the transmitter device.

15. The receiver device of claim 14, wherein the first compensator is configured to determine the first activation offset by calculating a frequency-derived offset.

16. The receiver device of claim 14, wherein the first compensator is configured to determine the first activation offset by calculating a time correlation-derived offset.

17. The receiver device of claim 15, wherein the first compensator is configured to further determine the first activation offset by calculating a time correlation-derived offset.

18. The receiver device of claim 14, wherein the clock inaccuracy comprises errors between a transmitter clock used to modulate a digital signal into symbols with respect to a first receiver clock used to demodulate the symbols.

19. The receiver device of claim 14, wherein the receiver device further comprises a second clock configured to track time spent operating in the low power mode and a second compensator configured to determine a second activation offset corresponding to a clock inaccuracy present in the second clock;
wherein the receiver device is configured to adjust the early reception interval based on the second activation offset.

20. The receiver device of claim 19, wherein the receiver device is configured to adjust the early reception interval by changing a number of timing pulses from the second clock that are counted before entering active mode.

21. The receiver device of claim 20, wherein the receiver device is further configured to adjust the early reception interval by varying a frequency of the second clock.

22. The receiver device of claim 19, wherein the receiver device further comprises a temperature sensor and wherein the second compensator is configured to determine the second activation offset by sensing an operational temperature of the receiver device with the temperature sensor and estimating a clock error correlated to the operational temperature.

23. The receiver device of claim 22, wherein the second compensator is further configured to correct the operational temperature based on a chip temperature profile related to differences in location and a distance of a source of the second clock source relative to a location of the temperature sensor.

24. The receiver device of claim 19, wherein the second compensator is configured to determine the second activation offset by estimating a clock error based on an operational condition of the receiver device.

25. The receiver device of claim 19, wherein the second compensator is configured to determine the second activation offset by performing a piecewise linear estimation of clock error over time.

26. The receiver device of claim 14, wherein the receiver device is further configured to receive a beacon during the scheduled beacon transmission, verify an identification value associated with the beacon and determine the early reception interval at least partially based on the first activation offset if the verification confirms the beacon originated from the transmitter device.
